(19) United States
(12) Patent Application Publication
(10) Pub. No.: US 2015/0330810 A1
(43) Pub. Date: Nov. 19, 2015

(54) DEVICE FOR DETECTING AN ANGULAR TRAVEL OF A VEHICLE CONTROL MEMBER

(71) Applicant: SAGEM DEFENSE SECURITE, Boulogne-Billancourt (FR)

(72) Inventor: Guillaume POINTEL, Boulogne Billancourt (FR)

(21) Appl. No.: 14/651,121

(22) PCT Filed: Dec. 13, 2013
(86) PCT No.: PCT/EP2013/076532

§ 371 Date: Jun. 10, 2015

(30) Foreign Application Priority Data
Dec. 19, 2012 (FR) 1262318

(51) Int. Cl. G01D 5/04

(52) U.S. Cl. CPC G01D 5/04

(57) ABSTRACT

The invention relates to a device for detecting angular movement of a control member of a vehicle, the device comprising at least one driving portion (1) arranged to be driven in turning by the control member about a first axis (X₀) and at least one sensor for measuring angular movement of the driving portion about the first axis (11, 12, 13), the sensor having a pivot input shaft (14, 15, 16) that extends in a direction substantially parallel to the first axis and that is connected to move in turning with the driving portion by connection means. According to the invention, the connection means comprise at least a first connecting rod (17, 35) hinged to the driving part and at least one link (21, 22, 23) the link being hinged at a first end (21a, 22a, 23a) to the first connecting rod and having a second end (21b, 22b, 23b) connected to move in turning with the input shaft of the sensor so that angular movement of the driving portion acts via the first connecting rod to drive corresponding angular movement of the input shaft of the sensor.

The invention relates to a device for detecting angular movement of a vehicle control member such as a throttle lever of an aircraft.

### TECHNOLOGICAL BACKGROUND OF THE INVENTION

In the field of aviation, the angular movement of the throttle lever is determined with the help of a device for detecting angular movement of the throttle lever, which device has a driving portion arranged to be driven in turning by said lever and sensors for measuring angular movement of the driving portion, which sensors are arranged around the driving portion. Each sensor has a spur gear secured to its pivot input shaft, with the various spur gears meshing with a toothed sector secured to the driving portion.

Thus, when the driving portion is caused to move in turning by the throttle lever, it drives rotation of the various gears and thus of the input shafts of the various sensors so that each sensor detects the angular movement of the throttle lever.

Nevertheless, such a device is found to be expensive and difficult to install. It is necessary to ensure that the gears mesh properly with the driving portion and it is also necessary to release a significant amount of space around the driving portion in order to receive the various gears and the associated sensors. Furthermore, slack can sometimes occur in the meshing between one or more gears and the driving portion, thereby falsifying the measurements of the associated sensors. It is then necessary to insert backlash take-up wheels between the gears in question and the driving portion, thereby making the detector device more complex and more voluminous.

Furthermore, certain applications, in particular in aviation, require the angular movement of the driving portion to be determined by a large number of sensors. It is then not possible to arrange all of the sensors around the driving portion because of the size of the sensors, and as a result it is not possible to have all of the spur gears concerned meshing directly with the driving portion. Certain sensors then need to be offset from the driving portion and their gears need to mesh with intermediate gears arranged between said gears and the driving portion.

Such a device is found to be even more complex and voluminous. In addition, because of the large number of gears, the measurements taken by the sensors are more likely to be erroneous.

### OBJECT OF THE INVENTION

An object of the invention is to propose a device for detecting angular movement of a vehicle control member that obviates the above-mentioned problems, at least in part.

### BRIEF DESCRIPTION OF THE INVENTION

In order to achieve this object, the invention provides a device for detecting angular movement of a control member of a vehicle, e.g. a throttle lever of an aircraft, the device comprising at least one driving portion arranged to be driven in turning by the control member about a first axis and at least one sensor for measuring angular movement of the driving portion about the first axis, the sensor having a pivot input shaft that extends in a direction substantially parallel to the first axis and that is connected to move in turning with the driving portion by connection means.

According to the invention, the connection means comprise at least a first connecting rod hinged to the driving part and at least one link member having a first end hinged to the connecting rod and a second end connected to move in turning with the input shaft of the sensor so that angular movement of the driving portion acts via the first connecting rod to drive corresponding angular movement of the input shaft of the sensor.

Thus, the connection means require few elements for connecting the driving portion to move in turning with the various shafts of the sensors. Furthermore, the connection means of the invention make it possible to avoid using slack-originating elements such as gears.

The device of the invention thus makes it possible to detect very accurately the angular movement of the movement member while being not very complex.

Furthermore, the driving portion may be of small size since it is only the connection rod that needs to be hinged thereto, thereby limiting the size of the device of the invention.

In addition, the connection means enable the sensors to be offset from the driving portion, thus making it possible to have a large number of sensors connected to move in turning with the driving portion.

### BRIEF DESCRIPTION OF THE DRAWINGS

The invention can be better understood in the light of the following description of a non-limiting embodiment of the invention given with reference to the accompanying figures, in which:

FIG. 1 is a diagrammatic perspective view of a detector device in a first embodiment of the invention;

FIG. 2 is a front view of the device shown in FIG. 1;

FIG. 3 is a front view of the detector device in a second embodiment of the invention; and

FIG. 4 is a front view of the detector device in a third embodiment of the invention.

### DETAILED DESCRIPTION OF THE INVENTION

The detector device of the invention is used in this example to measure the angular movement of an aircraft throttle lever. This application is naturally not limiting and the invention may be applied to measuring the angular movement of any other control member of a vehicle, such as for example rudder pedals, or an accelerator pedal or lever.

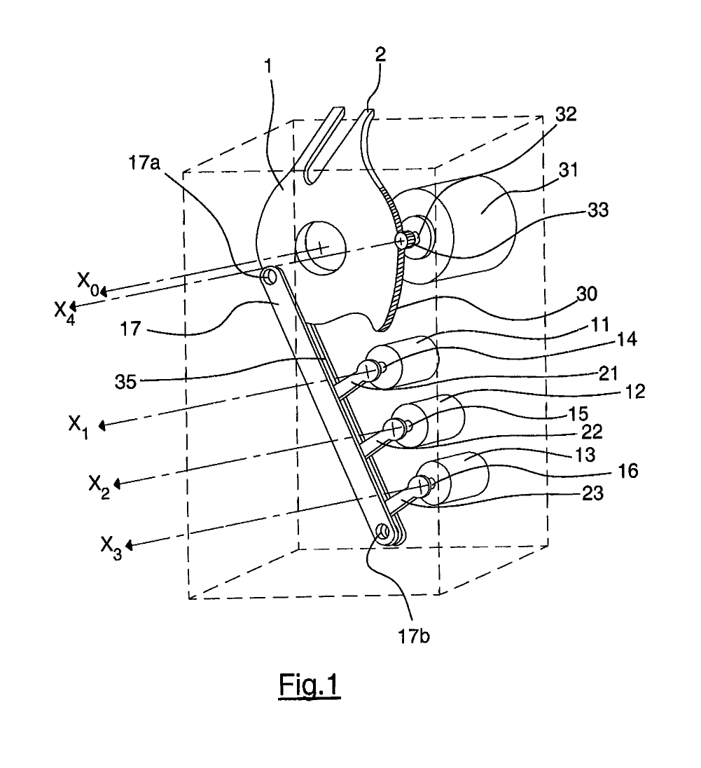

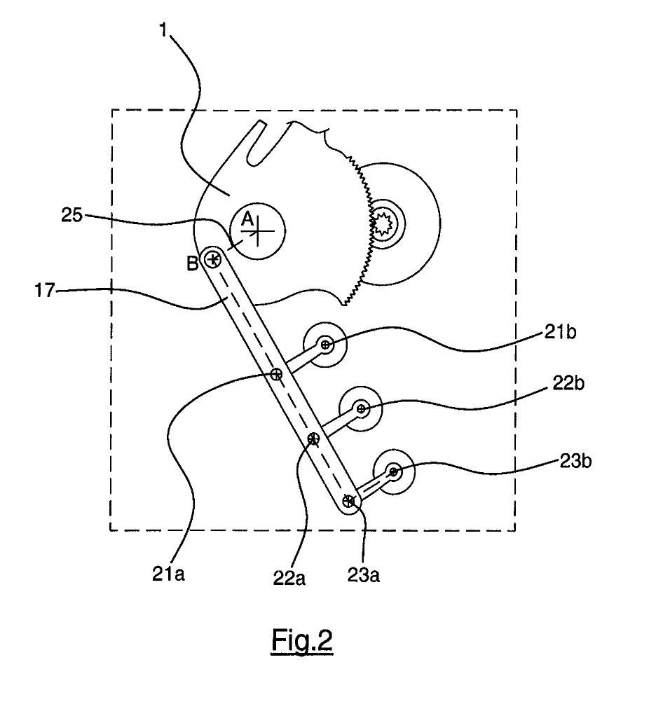

With reference to FIGS. 1 to 2 and in a first embodiment, the device of the invention comprises a driving portion 1 arranged to be driven in turning by the throttle lever (not shown) about a first axis of rotation X₀. For example, the driving portion 1 has a handle 2 that is constrained to move in turning with the throttle lever.

In a preferred embodiment, the device has a first series of sensors for measuring angular movement of the driving portion 1 about the first axis X₀. In this example, the first series of sensors comprises a first sensor 11, a second sensor 12, and a third sensor 13. The first sensor 11 has a pivot input shaft 14 that extends along a direction X₁ that is substantially parallel to the first axis X₀. Likewise, the second sensor 12 has a pivot input shaft 15 that extends along a direction X₂ that is substantially parallel to the first axis X₀, and the third sensor 13 has a pivot input shaft 16 that extends along a direction X₃ that is substantially parallel to the first axis X₀. In this example, all three sensors are sensors of the inductive angular type, such as sensors of the rotary variable differential transformer (RVDT) type.

The device also has connection means connecting each sensor 11, 12, and 13 to move in turning together with the driving portion 1.

In the invention, the connection means comprise a first connecting rod 17 hinged to the driving portion 1 at a first end 17a.

In this example, the connection means further comprise a first series of links comprising a first link 21 associated with the first sensor 11, a second link 22 associated with the second sensor 12, and a third link 23 associated with the third sensor 13. In this example, all three links are substantially parallel to one another and they are all substantially of the same first length.

The first link 21 has a first end 21a hinged to the first connecting rod 17 and a second end 21b that is connected to turn with the input shaft 14 of the first sensor 11. As can be seen more clearly in FIG. 2, the driving portion 1, the first connecting rod 17, and the first link 21 are thus mechanically coupled in such a manner that the first connecting rod 17, the first link 21, and a segment 25 extending between the center of rotation A of the driving portion 1 about the first axis X₀ and a center B of the hinge between the first end 17a of the first connecting rod 17 and the driving portion 1 together form a deformable parallelogram.

Thus, the first link 21 is associated with the first sensor 11 in such a manner that angular movement of the driving portion 1 acts via the first connecting rod 17 to drive corresponding angular movement of the input shaft 14 of the first sensor 11. The term “corresponding movement” is used in this example to mean movement that is identical for the axis of the sensor. The angular range covered by the sensor is thus the same as the angular range of the driving portion 1. Since the driving portion 1 is constrained to move in turning with the throttle lever, the angular movement of the input shaft 14 of the first sensor 11 thus makes it possible to determine the angular movement of the throttle lever.

In the same manner, the second link 22 has a first end 22a that is hinged to the first connecting rod 17 and a second end 22b that is constrained to turn with the input shaft 15 of the second sensor 12 such that the driving portion 1, the first connecting rod 17, and the second link 22 are mechanically coupled together so that the first connecting rod 17, the second link 22, and the segment 25 together form a deformable parallelogram. In addition, the third link 23 has a first end 23a that is hinged to the first connecting rod 17 and a second end 23b that is constrained to turn with the input shaft 16 of the third sensor 13 such that the driving portion 1, the first connecting rod 17, and the third link 23 are mechanically coupled together so that the first connecting rod 17, the third link 23, and the segment 25 together form a deformable parallelogram.

Since the three links 21, 22, and 23 are substantially parallel to one another and of the same first length, the three sensors 11, 12, and 13 are thus in alignment relative to the driving portion, i.e. the centers of the connections between the second ends of each of the links and the axes of the associated sensors are all in alignment with the center of rotation A.

Thus, angular movement of the driving portion 1 acts via the first connecting rod 17 to drive corresponding angular movement for each of the three input shafts 14, 15, and 16 of the three sensors 11, 12, and 13, all of which are suitable for determining said angular movement of the driving portion 1 and thus the angular movement of the throttle lever.

Consequently, the device of the invention serves to connect the driving portion 1 in turning with an entire row of sensors simultaneously, thus making it possible to limit any slack that might exist between the connection means and thereby improve the measurements taken by the various sensors. Furthermore, the device is not very complex, with the connection means being very simple to connect to the driving portion and to the various sensors.

Preferably, the first connecting rod 17 is hinged to the third link 23 at a second end 17b of the first connecting rod 17, the third link 23 being the link that is furthest from the driving portion 1. As a result, the first connecting rod 17 is of a length that is adjusted to match the number of input shafts of the sensors to be envisaged.

In this particular embodiment, the driving portion 1 is plane and presents a toothed sector 30 occupying at least a portion of its thickness. The device then has a fourth measurement sensor 31 for measuring angular movement of the driving portion 1 about the first axis X₀, which sensor has a pivot input shaft 32 that extends in a direction X₄ that is substantially parallel to the first axis X₀. In this example, the connection means comprise a spur gear 33 that is constrained to turn with the input shaft 32 of the fourth sensor 31 and that is mechanically coupled to the toothed sector 30 in order to provide a rotary connection between the driving portion 1 and the input shaft of the fourth sensor 31.

Thus, during angular movement of the throttle lever, the driving portion 1 meshes with the gear 33 and thus with the input shaft 32 of the fourth sensor 31, thereby enabling said sensor to determine said angular movement.

By means of the first connecting rod 17, it is possible to offset some of the sensors away from the driving portion 1 and thus to arrange other sensors around the driving portion 1 for engaging directly with the driving portion. The bulk of the device of the invention is thus reduced.

In this example, and advantageously, the connection means include a second connecting rod 35 that extends substantially parallel to the first connecting rod 17. In this example the second connecting rod 35 is hinged at a first end to the driving portion 1. Furthermore, the second connecting 35 is hinged to each of the first ends of each of the links. Thus, the driving portion 1, the second connecting rod 35, and each of the links 21, 22, and 23 are mechanically coupled together in such a manner that the second connecting rod 17, each link 21, and a segment extending between the center of rotation A and a hinge center between the first end of the second connecting rod 35 and the driving portion 1 together form a deformable parallelogram. Under such circumstances, angular movement of the driving portion 1 acts via the first connecting rod 17 and also via the second connecting rod 35 to drive corresponding angular movement of the input shaft of the sensors.

If one of the connecting rods 17 or 35 is broken or damaged so that it can no longer drive turning movement of the links, the other connecting rod can perform this drive on its own. The connection means of the invention are thus very reliable.

Preferably, the first connecting rod 17 and the second connecting rod 35 extend on either side of the driving portion and of each of the links. Thus, each link 21, 22, and 23 is hinged on one of its faces to the first connecting rod 17 and on its other face to the second connecting rod 35 such that each link 21, 22, and 23 lies between the two connecting rods 17 and 35. A fraction of the driving portion 1 and the first ends of the links are thus received between the two connecting rods 17 and 35 that extend facing each other.

The arrangement of the two connecting rods 17 and 35 thus makes it possible to have a device that is reliable and not very bulky.

The second connecting rod 35 is preferably hinged to the third link 23 at a second end of the second connecting rod 35. As a result, the second connecting rod 35 is of a length that matches the number of sensor shafts to be engaged.

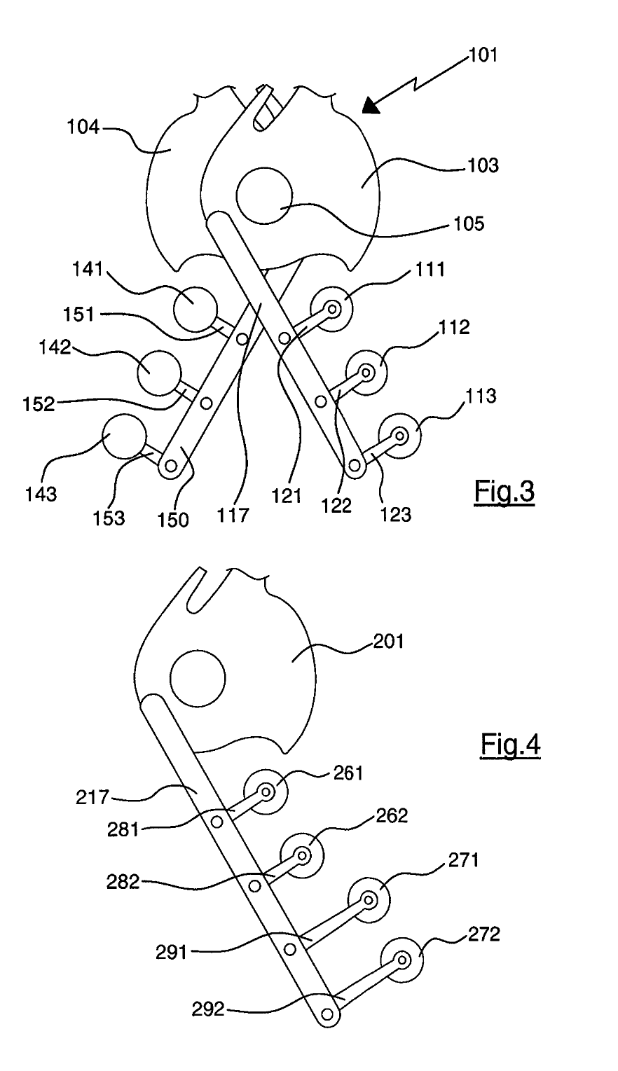

A second embodiment of the invention is described below, with reference to FIG. 3. Elements that are common with the first embodiment retain the same reference numbers plus one hundred.

In this second embodiment, in addition to the first series of sensors arranged as in the first embodiment, the device of the invention also includes a second series of sensors for measuring angular movement of the driving portion 101 about the first axis X₀. In this example, the second series of sensors comprises a first sensor 141, a second sensor 142, and a third sensor 143. The three sensors of the second series 141, 142, 143 all have respective pivot input shafts that extend along directions that are substantially parallel to the first axis X₀.

The device also has connection means connecting each sensor of the second series to the driving portion 101. The connection means thus comprise a second connecting rod 150 having a first end hinged to the driving part 101. In this example, the connection means further comprise a second series of links comprising a first link 151 associated with the first sensor 141 of the second series, a second link 152 associated with the second sensor 142 of the second series, and a third link 153 associated with the third sensor 143 of the second series. The links of the second series 151, 152, 153 are substantially parallel to one another and they are all of substantially the same second length.

Each link of the second series 151, 152, 153 is associated with a respective one of the sensors of the second series 141, 142, 143 so as to have a first end hinged to the second connecting rod 150 and a second end constrained to rotate with the input shaft of the associated sensor. Each link of the second series 151, 152, 153 is thus associated with a respective one of the sensors of the second series 141, 142, 143 so that angular movement of the driving portion 101 acts via the second connecting rod 150 to drive corresponding angular movement of the input shaft of the associated sensor.

Under such circumstances, angular movement of the driving portion 101 acts via the first connecting rod 117 to drive corresponding angular movement of the input shafts of the sensors of the first series 111, 112, 113, and simultaneously acts via the second connecting rod 150, to drive corresponding angular movement of the input shafts of the sensors of the second series 141, 142, 143.

It is thus possible to drive various sensors of a first series 111, 112, 113 that are in alignment relative to the driving portion 101, and various sensors of a second series 141, 142, 143 that are in alignment relative to the driving portion 101, but without being in alignment with the sensors of the first series 111, 112, 113. By such an arrangement, the device of the invention makes it possible to connect together in turning a large number of input shafts of sensors for measuring angular movement of the driving portion 101, while conserving a volume that is small, and while ensuring that said angular movement is properly measured. In addition, it is possible to avoid having all of the sensors in alignment, thereby simplifying the device of the invention.

In a preferred embodiment, the driving portion 101 has a first element 103 of plane shape and a second element 104 of plane shape, the first element 103 being secured to the second element 104 by a shaft 105 extending between the two elements 103 and 104, by forming a spacer. The shaft 105 is constrained to move in turning with the throttle control lever so that angular movement of the throttle lever drives corresponding movement of both elements 103 and 104. The first connecting rod 107 in this example is hinged at its first end to the first element 103 and a second connecting rod 150 in this example is hinged at its first end to the second element 104. The first ends of both connecting rods 117, 150 are thus driven to move in turning by the driving portion 101 without any risk of touching each other, since they do not extend in the same plane, given that the two elements 104 and 105 are spaced apart by the shaft 105.

A third embodiment of the invention is described below, with reference to FIG. 4. Elements in common with the first embodiment conserve the same reference numbers plus two hundred.

In this third embodiment, the device of the invention has a first series of sensors for measuring angular movement of the driving portion 201 about a first axis X₀. In this example, the first series of sensors comprises a first sensor 261 and a second sensor 262. The device also has a second series of sensors for measuring angular movement of the driving portion 201 about the first axis X₀. In this example, the second series of sensors comprises a first sensor 271 and a second sensor 272. Both sensors of the first series 261, 262 and both sensors of the second series 271, 272 have respective pivot input shafts that extend along directions that are substantially parallel to the first axis X₀.

The device also has connection means connecting each sensor of the first series 261, 262 and of the second series 271, 272 to move in turning with the driving portion 201.

The connection means thus comprise a first series of links 281, 282, said links being substantially parallel to one another and all being of substantially the same first length. Each link of the first series 281, 282 is associated with a respective one of the sensors of the first series 261, 262 in such a manner as to be hinged at a first end to the first connecting rod 217 and having a second end constrained to move in turning with the input shaft of the associated sensor. Each link of the first series 281, 282 is thus associated with a sensor of the first series 261, 262 so that angular movement of the driving portion 201 acts via the first connecting rod 217 to drive corresponding angular movement of the input shaft of the associated sensor.

The connection means also include a second series of links 291, 292, the links of the second series 291, 292 being all substantially parallel to the links of the first series 281, 282 and being of substantially the same second length, the second length being different from the first length. Each link of the second series 291, 292 is associated with a respective one of the sensors of the second series 271, 272 so as to be hinged at a first end to the first connecting rod 217 and having a second end that is constrained to move in turning with the input shaft of the associated sensor. In the same manner as for the first series, each link in the second series 291, 292 is thus associated with a respective sensor of the second series 271, 272 so that angular movement of the driving portion 201 acts via the first connecting rod 217 to drive corresponding angular movement of the input shaft of the associated sensor.

Consequently, the same connecting rod serves to connect the driving portion in turning with sensors of a first series of sensors that are mutually in alignment and with the sensors of a second series of sensors that are in mutual alignment but that are not aligned with the sensors of the first series.

By means of such an arrangement, the device of the invention makes it possible to connect together in turning a large number of input shafts of sensors for measuring angular movement of the driving portion 201, while conserving a small volume and ensuring that the angular movement of said driving portion is correctly measured by the sensors. In addition, there is no need to have all of the sensors in alignment, thereby simplifying the device of the invention.

Naturally, the invention is not limited to the embodiments described and it is possible to apply embodiment variations thereto without going beyond the ambit of the invention as defined by the claims.

In particular, although the present description relates to three distinct embodiments, the three embodiments could be mixed.

The device of the invention could thus omit having a sensor engaged via a spur gear so as to have only sensors that are engaged via a connecting rod and link system.

The device could have some number of sensors other than those described.

The sensor(s) mentioned could be of a type other than that described. For example, the sensors could be capacitive angle sensors or indeed optical coders, . . . .

Although in the third embodiment shown in FIG. 4, the first series of sensors is followed by the second series of sensors, the sensors of the first and second series could be arranged differently. For example, the sensors of the first series could be arranged in alternation with the sensors of the second series. In a variant of this third embodiment, the links of the first series and of the second series could all be of the same size and the connecting rod could present two different widths depending on whether it is to drive rotary movement of the links of the first series or of the links of the second series.

1. A device for detecting angular movement of a control member of a vehicle, e.g. a throttle lever of an aircraft, the device comprising at least one driving portion arranged to be driven in turning by the control member about a first axis and at least one sensor for measuring angular movement of the driving portion about the first axis, the sensor having a pivot input shaft that extends in a direction substantially parallel to the first axis and that is connected to move in turning with the driving portion by connection means, the device being characterized in that the connection means comprise at least a first connecting rod hinged to the driving part and at least one link member having a first end hinged to the first connecting rod and having a second end connected to move in turning with the input shaft of the sensor so that angular movement of the driving portion acts, via the first connecting rod, to drive corresponding angular movement of the input shaft of the sensor.

2. The device according to claim 1, having a first series of sensors for measuring angular movement of the driving portion about the first axis each sensor having a pivot input shaft that extends in a direction substantially parallel to the first axis and that is connected to move in turning with the driving portion by the connection means, the connection means comprising a first series of links members, each link member being associated with one of the sensors so as to have a first end hinged to the first connecting rod and a second end connected to move in turning with the input shaft of the associated sensor so that angular movement of the driving portion drives corresponding angular movement of the input shaft of the associated sensor, the links members being substantially parallel to one another and all being substantially the same first length.

3. The device according to claim 2, further including a second series of sensors for measuring angular movement of the driving portion about the first axis, each sensor of the second series having a pivot input shaft that extends in a direction substantially parallel to the first axis and that is connected to move in turning with the driving portion by the connection means, the connection means having a second series of links members, each link member of the second series being associated with a respective one of the sensors of the second series so as to have a first end hinged to the first connecting rod and a second end connected to move in turning with the input shaft of the associated sensor so that angular movement of the driving portion drives corresponding angular movement of the input shaft of the associated sensor, the links members of the second series all being substantially parallel to the links members of the first series and all being substantially the same second length, the second length being different from the first length.

4. The device according to claim 1, further including a second sensor for measuring angular movement of the driving portion about the first axis, the second sensor having a pivot input shaft that extends in a direction substantially parallel to the first axis and that is connected to move in turning with the driving portion by the connection means, the connection means including a second connecting rod hinged to the driving part and a second link associated with the second sensor so as to have a first end hinged to the second connecting rod and a second end connected to move in turning with the input shaft of the second sensor so that angular movement of the driving portion acts via the second connecting rod to drive corresponding angular movement of the input shaft of the second sensor.

5. The device according to claim 1, wherein the connection means include a second connecting rod that extends substantially parallel to the first connecting rod and that is hinged to the driving portion and to the link member such that angular movement of the driving portion acts, via the first connecting rod and the second connecting rod to drive corresponding angular movement of the input shaft of the sensor.

6. The device according to claim 5, wherein the first connecting rod and the second connecting rod extend on either side of the driving portion and of the link member.

7. The device according to claim 1, wherein the sensor, is a sensor of the inductive angular sensor type.
